(19) United States
(12) Patent Application Publication
(10) Pub. No.: US 2024/0303219 A1
(43) Pub. Date: Sep. 12, 2024

(54) METHOD, ELECTRONIC DEVICE, AND COMPUTER PROGRAM PRODUCT FOR MONITORING STORAGE RESOURCE OBJECTS

(71) Applicant: Dell Products L.P., Round Rock, TX (US)

(72) Inventor: Mao Li, Bazhong (CN)

(21) Appl. No.: 18/368,206

(22) Filed: Sep. 14, 2023

(30) Foreign Application Priority Data
Mar. 6, 2023 (CN) 202310210479.0

(51) Int. Cl. G06F 16/11

(52) U.S. Cl. CPC G06F 16/128

(57) ABSTRACT

Techniques monitor storage resource objects. Such techniques involve monitoring a first number of storage resource objects that have been consumed in a storage system, the consumed storage resource objects storing a system file and/or volume and snapshots of the system file and/or snapshots of the volume. Such techniques further involve determining a second number of remaining storage resource objects based on the first number and the performance of the storage system. Such techniques further involve sending the first number and the second number to a user device to display the first number and the second number by the user device. The second number decreases as the first number increases. Such techniques can directly and intuitively provide users with the usage of storage resource objects in a storage system from the perspective of number attributes, thus providing reference for users when creating protection policies, and further improving user experience.

### CROSS-REFERENCE TO RELATED APPLICATION

This application claims priority to Chinese Patent Application No. CN202310210479.0, on file at the China National Intellectual Property Administration (CNIPA), having a filing date of Mar. 6, 2023, and having “METHOD, ELECTRONIC DEVICE AND COMPUTER PROGRAM PRODUCT FOR MONITORING STORAGE OBJECTS” as a title, the contents and teachings of which are herein incorporated by reference in their entirety.

### TECHNICAL FIELD

Embodiments of the present disclosure relate to the field of computer processing, and more specifically, to a method, an electronic device, and a computer program product for monitoring storage resource objects.

### BACKGROUND

With the development of data storage technologies, various data storage devices can already provide users with higher and higher data storage capacities. While improving the data storage capacities, users also put forward higher and higher demands for the reliability of data storage devices. Under this demand, snapshots come into being. One function of snapshots is to perform data backup and recovery of a storage system. For example, when a storage device has an application failure or a file is damaged, data can be recovered through snapshots, and then the data can be restored to a state at an available point in time. Another function of snapshots is to provide another data access channel for users. For example, when original data is processed for on-line applications, users can access the snapshot data and can also use the snapshots for other tasks such as testing. At present, snapshots have become an indispensable function of storage systems.

### SUMMARY OF THE INVENTION

Embodiments of the present disclosure provide a method, an electronic device, and a computer program product for monitoring storage resource objects.

According to a first aspect of the present disclosure, a method for monitoring storage resource objects is provided. The method includes monitoring a first number of storage resource objects that have been consumed in a storage system, the consumed storage resource objects storing a system file and/or volume and snapshots of the system file and/or snapshots of the volume. The method further includes determining a second number of remaining storage resource objects based on the first number and the performance of the storage system. The method further includes sending the first number and the second number to a user device to display the first number and the second number by the user device, where the second number decreases as the first number increases.

According to a second aspect of the present disclosure, an electronic device is provided. The electronic device includes at least one processor; and a memory coupled to the at least one processor and having instructions stored thereon, wherein the instructions, when executed by the at least one processor, cause the electronic device to perform actions including: monitoring a first number of storage resource objects that have been consumed in a storage system, the consumed storage resource objects storing a system file and/or volume and snapshots of the system file and/or snapshots of the volume; determining a second number of remaining storage resource objects based on the first number and the performance of the storage system; and sending the first number and the second number to a user device to display the first number and the second number by the user device, where the second number decreases as the first number increases.

According to a third aspect of the present disclosure, a computer program product is provided. The computer program product is tangibly stored on a non-volatile computer-readable medium and includes machine-executable instructions, wherein the machine-executable instructions, when executed, cause a machine to perform steps of the method in the first aspect of the present disclosure.

### BRIEF DESCRIPTION OF THE DRAWINGS

By more detailed description of example embodiments of the present disclosure with reference to the accompanying drawings, the above and other objectives, features, and advantages of the present disclosure will become more apparent, wherein identical reference numerals generally represent identical components in the example embodiments of the present disclosure.

FIG. 1 shows a schematic diagram of an example system in which an embodiment of the present disclosure can be implemented;

FIG. 2 shows a flow chart of a method for monitoring storage resource objects according to an embodiment of the present disclosure;

FIG. 3 shows an example graphical user interface for displaying a first number and a second number according to an embodiment of the present disclosure;

FIG. 4 shows a schematic diagram of an interface for displaying the number of snapshots created by a snapshot scheduler according to an embodiment of the present disclosure;

FIG. 5 shows a schematic flow chart of monitoring storage resource objects to be consumed by a snapshot scheduler according to an embodiment of the present disclosure;

FIG. 6 shows a schematic diagram of an interface for displaying a prompt message at a user device according to an embodiment of the present disclosure;

FIG. 7 shows a schematic diagram of a snapshot scheduler providing an interface according to an embodiment of the present disclosure;

FIG. 8 shows a detailed schematic block diagram of a snapshot scheduler providing an interface according to an embodiment of the present disclosure;

FIG. 9 shows a schematic block diagram of migration of storage resource objects according to an embodiment of the present disclosure; and

FIG. 10 shows a simplified block diagram of a device suitable for implementing an example embodiment of the present disclosure.

In the accompanying drawings, identical or corresponding numerals represent identical or corresponding parts.

### DETAILED DESCRIPTION

The individual features of the various embodiments, examples, and implementations disclosed within this document can be combined in any desired manner that makes technological sense. Furthermore, the individual features are hereby combined in this manner to form all possible combinations, permutations and variants except to the extent that such combinations, permutations and/or variants have been explicitly excluded or are impractical. Support for such combinations, permutations and variants is considered to exist within this document.

It should be understood that the specialized circuitry that performs one or more of the various operations disclosed herein may be formed by one or more processors operating in accordance with specialized instructions persistently stored in memory. Such components may be arranged in a variety of ways such as tightly coupled with each other (e.g., where the components electronically communicate over a computer bus), distributed among different locations (e.g., where the components electronically communicate over a computer network), combinations thereof, and so on.

The embodiments of the present disclosure will be described in more detail below with reference to the accompanying drawings. Although the accompanying drawings show some embodiments of the present disclosure, it should be understood that the present disclosure may be implemented in various forms, and should not be explained as being limited to the embodiments stated herein. Rather, these embodiments are provided for understanding the present disclosure more thoroughly and completely. It should be understood that the accompanying drawings and embodiments of the present disclosure are for example purposes only, and are not intended to limit the protection scope of the present disclosure.

In the description of the embodiments of the present disclosure, the term “include” and similar terms thereof should be understood as open-ended inclusion, that is, “including but not limited to.” The term “based on” should be understood as “based at least in part on.” The term “an embodiment” or “the embodiment” should be understood as “at least one embodiment.” The terms “first,” “second,” and the like may refer to different or identical objects. Other explicit and implicit definitions may also be included below.

At present, snapshots have become an indispensable function in a storage device to protect data, thus enhancing reliability of the storage device. One function of snapshots is to perform data backup and recovery of a storage system, and another is to provide a user with an alternative data access channel. Snapshots play an increasingly important role in a storage system.

In a storage system, a user may automatically create snapshots for a volume or system file by creating a protection strategy. If a plurality of snapshots have been created for the system file and volume, it may be difficult for the user to calculate the number of storage objects that will be consumed or created next, and the user may not even realize that the number of storage resource objects in the system has been exhausted and no snapshots can be created. In this case, the storage system usually only issues an alert reporting the failure of snapshot creation after the creation of snapshots has failed, but this may only worry and bother the user and does not actually protect data in the storage system.

Thus, at least to address the above problem and other potential problems, an embodiment of the present disclosure proposes a method for monitoring storage resource objects. The method includes monitoring a first number of storage resource objects that have been consumed in a storage system, the consumed storage resource objects storing a system file and/or a volume and snapshots of the system file and/or snapshots of the volume. The method further includes determining a second number of remaining storage resource objects based on the first number and the performance of the storage system. The method further includes sending the first number and the second number to a user device to display the first number and the second number by the user device, where the second number decreases as the first number increases. The method for monitoring storage resource objects according to the embodiments of the present disclosure can directly and intuitively provide users with the usage of storage resource objects in the storage system and the situation of remaining available storage resource objects from the perspective of number attributes, thus providing reference for users when creating protection policies to automatically create snapshots for volumes or system files, thereby avoiding the failure of snapshot creation, further providing sufficient protection for data in the storage system, and further improving the user experience.

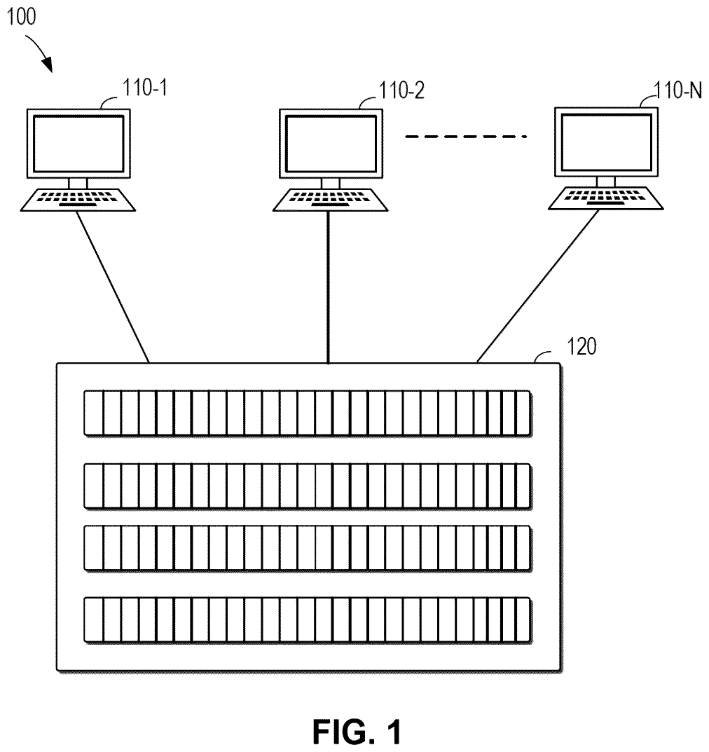

Embodiments of the present disclosure will be further described in detail with reference to the accompanying drawings below. FIG. 1 is a schematic diagram of example system 100 in which an embodiment of the present disclosure can be implemented.

Example system 100 may include a plurality of user devices 110-1, 110-2 . . . , 110-N, where N is a positive integer greater than or equal to 1. The plurality of user devices 110-i (where i is a positive integer and 1≤i≤N) are connected to storage system 120 for storing data using storage resources of the storage system. In some embodiments, the plurality of user devices 110-i may be multiple devices within the same local area network. In some other embodiments, the plurality of user devices 110-i may be from different local area networks. The present disclosure does not limit a positional relationship between the plurality of user devices 110-i.

In some embodiments, the plurality of user devices 110-i may be connected to storage system 120 through various types of networks or links. For example, one or more of the plurality of user devices may be connected to the storage system from a remote location through various types of networks. In addition, one or more of the plurality of user devices may be locally connected to the storage system through various types of cables. The present disclosure does not limit the type of a network or link that connects user devices 110-i to storage system 120.

In some embodiments, user device 110-1 to user device 110-N may be devices of the same type or different types, which is not limited in the present disclosure. User device 120 may include, but is not limited to, a personal computer, a server computer, a handheld or laptop device, a mobile device (such as a mobile phone, a personal digital assistant (PDA), and a media player), a multi-processor system, a consumer electronic product, a wearable electronic device, an intelligent home device, a minicomputer, a mainframe computer, an edge computing device, a distributed computing environment including any of the above systems or devices, etc.

Storage system 120 may include a redundant array of independent disks (RAID) arranged as a disk array, as shown in FIG. 1. User device 110-i may store data in a plurality of storage disks of storage system 120 and perform operations such as access to the plurality of storage disks. The “disk” described here may refer to any non-volatile storage medium currently known or to be developed in the future, including but not limited to a magnetic disk, an optical disk, a solid status disk (SSD), or the like. In the description herein, it will be collectively referred to as “disk” for description. It should be understood, however, that this is for convenience of description only and does not imply any limitation on the scope of the present disclosure. Those skilled in the art may select a suitable non-volatile storage medium from storage system 120 according to application requirements. In addition, the disk array in storage system 120 shown in FIG. 1 is only illustrative. Those skilled in the art may set various numbers and arrangements of disks in storage system 120 according to actual needs, which is not limited in the present disclosure.

As shown in FIG. 1, a system file and/or volume of user device 110-i may be stored in storage system 120. User device 110-i may create snapshots of the system file/snapshots of the volume in storage system 120. Thus, in the event of an error in a source system file or volume, data protection may be achieved by recovering the source system file or volume from the snapshots of the system file and/or the snapshots of the volume.

In some embodiments, storage system 120 may monitor a first number of storage resource objects that have been consumed in storage system 120. In some embodiments, the consumed storage resource objects store a system file and/or volume and snapshots of the system file and/or snapshots of the volume. Storage system 120 may also determine a second number of remaining storage resource objects based on the first number and the performance of storage system 120. Storage device 120 may also send the first number and the second number to user device 110-i to display the first number and the second number to a user by user device 110-i, thereby providing a reference for the user to create a protection strategy.

The method for monitoring storage resource objects according to the embodiments of the present disclosure can directly and intuitively provide users with the usage of storage resource objects in the storage system and the situation of remaining available storage resource objects from the perspective of number attributes, thus providing reference for users when creating protection policies to automatically create snapshots for volumes or system files, thereby avoiding the failure of snapshot creation, further providing sufficient protection for data in the storage system, and further improving the user experience.

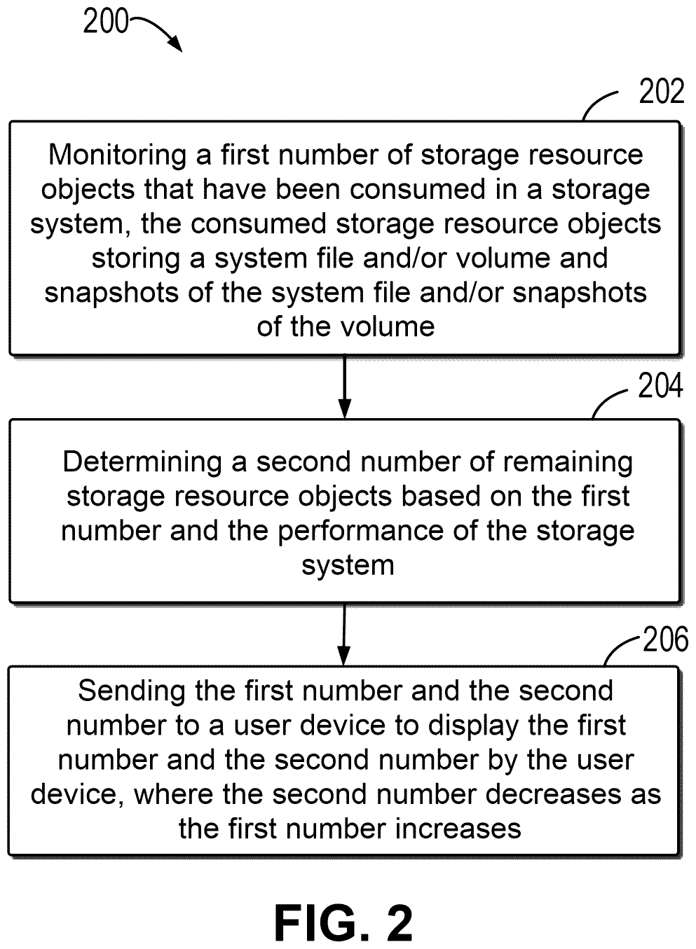

A block diagram of example storage system 120 in which embodiments of the present disclosure can be implemented has been described above with reference to FIG. 1. A flow chart of method 200 for monitoring storage resource objects according to an embodiment of the present disclosure will be described below with reference to FIG. 2. Actions involved in method 200 are described below with reference to storage system 120 as shown in FIG. 1. For example, in some embodiments, method 200 may be performed by storage system 120. It should be understood that method 200 may further include additional actions not shown and/or may omit actions shown, and the scope of the present disclosure is not limited in this aspect.

At block 202, storage system 120 may monitor the first number of storage resource objects that have been consumed in a storage system, where the consumed storage resource objects store a system file and/or volume and snapshots of the system file and/or snapshots of the volume, in other words, as a result of storing a system file and/or volume and snapshots of the system file and/or snapshots of the volume, the storage resource objects may be referred to as consumed storage resource objects.

In some embodiments, storage system 120 may provide a plurality of storage object resources for storing objects based on the performance of the storage system, where the number indicating the upper limit of storage resource objects that may be provided by storage system 120 may be referred to as an upper-limit number Nₗᵢₘᵢₜ. Storage system 120 may determine the upper-limit number Nₗᵢₘᵢₜ of available storage resource objects based on the performance of the storage system. Storage system 120 may select a part of the upper-limit number Nₗᵢₘᵢₜ to store the system file and/or volume and snapshots of the system file and/or snapshots of the volume. Storage system 120 may monitor the first number N_{consumed} of storage resource objects that have been consumed.

In some embodiments, storage system 120 may obtain, by counting, the first number N_{consumed} of storage resource objects that have been consumed. For example, storage system 120 may include a counter that increases by 1 whenever a storage resource object is consumed and decreases by 1 whenever a storage resource object is released, thereby achieving real-time monitoring of the number N_{consumed} of the consumed storage resource objects. It is to be understood that storage system 120 may also determine the first number N_{consumed} of the consumed storage resource objects by other counting methods, which is not limited in the present disclosure.

At box 204, storage system 120 may determine the second number N_{remaining} of remaining storage resource objects based on the first number N_{consumed} and the performance of the storage system. As described above, storage system 120 may determine the upper-limit number Nₗᵢₘᵢₜ of storage resource objects that can be provided based on the performance of the storage system. The upper-limit number Nₗᵢₘᵢₜ represents the upper limit of available storage resource objects that storage system 120 can provide. Storage system 120 may determine the second number N_{remaining} of remaining storage resource objects based on the first number N_{consumed} and the upper-limit number Nₗᵢₘᵢₜ. In some embodiments, N_{remaining}=Nₗᵢₘᵢₜ-N_{consumed}.

In some embodiments, since the upper-limit number Nₗᵢₘᵢₜ is determined based on the performance of the storage system, the upper-limit number Nₗᵢₘᵢₜ is determined where the performance of the storage system is determined. Accordingly, according to the above formula, it is known that the greater the first number N_{consumed} of storage resource objects that have been consumed, the smaller the number N_{remaining} of remaining available storage resource objects, and vice versa. In other words, the second number N_{remaining} decreases as the first number N_{consumed} increases.

At box 206, storage system 120 may send the first number N_{consumed} and the second number N_{remaining} to user device 110-i to display the first number N_{consumed} and the second number N_{remaining} by the corresponding user device 110-i. In some embodiments, storage system 120 may send the first number N_{consumed} and the second number N_{remaining} to one or more of user devices 110-1 to 110-N, which is not limited in the present disclosure.

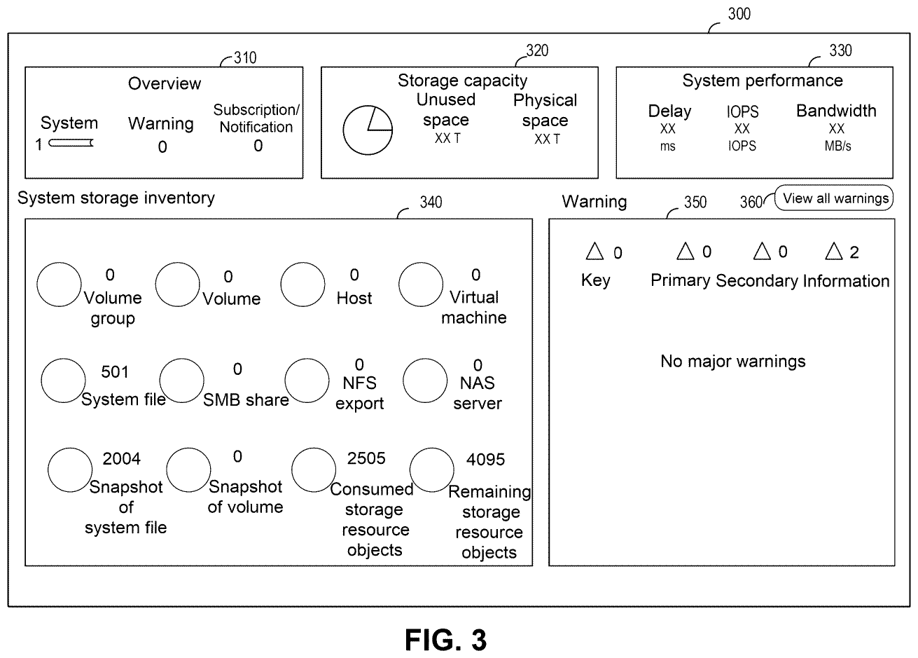

In some embodiments, a user device that receives the first number N_{consumed} and the second number N_{remaining} may display the numbers on a screen of the user device to prompt the user. An example graphical user interface 300 displaying the first number N_{consumed} and the second number N_{remaining} according to an embodiment of the present disclosure will be described below with reference to FIG. 3.

FIG. 3 shows example graphical user interface 300 displaying the first number N_{consumed} and the second number N_{remaining} according to an embodiment of the present disclosure. Graphical user interface 300 shown in FIG. 3 is used to display relevant information about storage system 120 to a user at user device 110-i. In an embodiment, user device 110-i may receive the first number N_{consumed} and the second number N_{remaining} from storage system 120 and display the first number N_{consumed} and the second number N_{remaining} in interface 300.

As shown in FIG. 3, interface 300 includes overview part 310 for displaying overview information of storage system 120, such as the name of the current storage system 120 (e.g., system 1), the number of warnings that have occurred, and the number of subscriptions/notifications (watch). Interface 300 may further include storage capacity display part 320 for displaying capacity information of storage system 120, such as the total physical storage capacity of the storage system, the capacity of unused space, and a relationship between the capacity of unused space and the capacity of used space displayed in the form of a graph and the like. Interface 300 may further include system performance display part 330 for displaying the performance of storage system 120, such as delay, size of read and write, and bandwidth. In addition, interface 300 may further include warning display part 350 for displaying information related to warnings.

In some embodiments, interface 300 may further include system storage inventory part 340 for displaying the number of storage resource objects consumed by various types of objects in storage system 120. The user device may display the first number N_{consumed} and the second number N_{remaining} from storage system 120 in this part. Since storage resource objects may be consumed by one or more types of objects, the user device may display the first number N_{consumed} based on the different types of consumed storage resource objects. For example, as shown in FIG. 3, there are two types of objects in the current storage system 120 to consume storage resource objects: a system file and snapshots of the system file. Accordingly, the user device may separately display in part 340 of interface 300 the numbers of storage resource objects consumed by the two types of objects, such as the number of storage resource objects consumed by a system file is 501, and the number of storage resource objects consumed by snapshots of the system file is 2004, and accordingly, the user device may also display the total number of storage resource objects that have been consumed, i.e., the first number N_{consumed}, such as the number 2505 as shown in FIG. 3. The user device may also display the number N_{remaining} of remaining storage resource objects in interface 300, such as the number 4905 as shown in FIG. 3.

Thus, the user device may display the first number N_{consumed} and the second number N_{remaining} from storage system 120 in user interface 300, thereby providing a reference for the user when creating a protection strategy for snapshot creation and avoiding the failure of snapshot creation because the user does not know the number of remaining storage resource objects.

In some embodiments, the first number N_{consumed} includes the number of snapshots of the system file and/or snapshots of the volume created by a snapshot scheduler for the system file and/or volume. The first number N_{consumed} may also include the number of snapshots of the system file and/or snapshots of the volume created for the system file and/or volume by other means. In the case where snapshots can be created by the snapshot scheduler as well as by other means, the first number N_{consumed} is the total number of snapshots created by the snapshot scheduler and snapshots created by other means.

In some embodiments, in addition to displaying the first number N_{consumed} and the second number N_{remaining} in the system in interface 300 shown in FIG. 3, the user device may also display other information related to the first number N_{consumed} and the second number N_{remaining} through the graphical user interface. For example, in the case where the first number N_{consumed} includes the number of snapshots of the system file and/or snapshots of the volume created by the snapshot scheduler for the system file and/or volume, the user device may also display in the interface the number of snapshots created by the snapshot scheduler, thereby providing a further reference for the user to create a protection strategy.

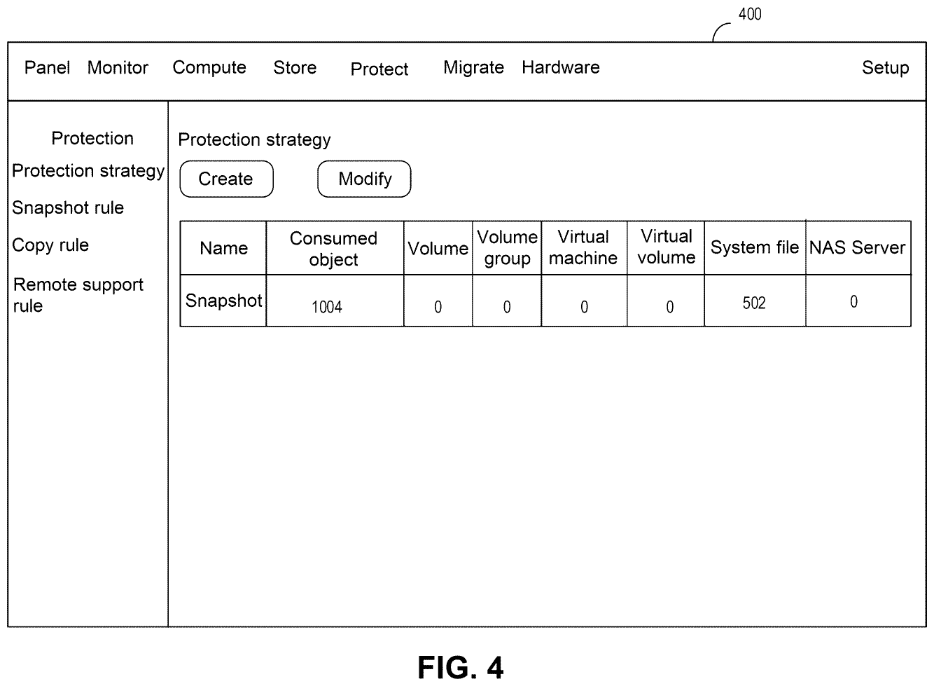

FIG. 4 shows a schematic diagram of an interface for displaying the number of snapshots created by a snapshot scheduler according to an embodiment of the present disclosure. Interface 400 in FIG. 4 may be displayed on a user device. As shown in FIG. 4, interface 400 shows the number of snapshots created by the snapshot scheduler (e.g., corresponding to the item “consumed objects” in FIG. 4), as well as the number of volumes, system files, and the like that are managed by the snapshot scheduler. In some embodiments, the number of snapshots created by the snapshot scheduler may be found out and obtained from log files of the snapshot scheduler. It is advantageous that, by displaying the number of snapshots created by the snapshot scheduler in interface 400, a reference can be provided to the user for setting a protection strategy for the snapshot scheduler.

It is to be understood that graphical user interface 300 in FIG. 3 and graphical user interface 400 in FIG. 4 are only schematically used to illustrate that the user device can display the information about the number of various types of storage resource objects. Those skilled in the art may use various design styles to display such number information, and the present disclosure does not limit the specific display details. In addition, the user device may also prompt the user with the number information of various types of storage resource objects in other ways (e.g., voice and tactile prompts), which is not limited in the present disclosure.

In some embodiments, the snapshot scheduler may have setting information (which may be referred to as the “protection strategy”) for creating snapshots. The snapshot scheduler may create snapshots for a system file and/or volume based on the setting information. Since there is an upper limit to the maximum number of storage resource objects that storage system 120 can provide, when it is determined that the number of snapshots to be created based on the setting information will cause the number of storage resource objects that have been and will be consumed to reach or exceed the upper limit, storage system 120 may send a prompt message to the user via user device 110-i so that the user may modify or adjust the setting information to avoid the error that will occur.

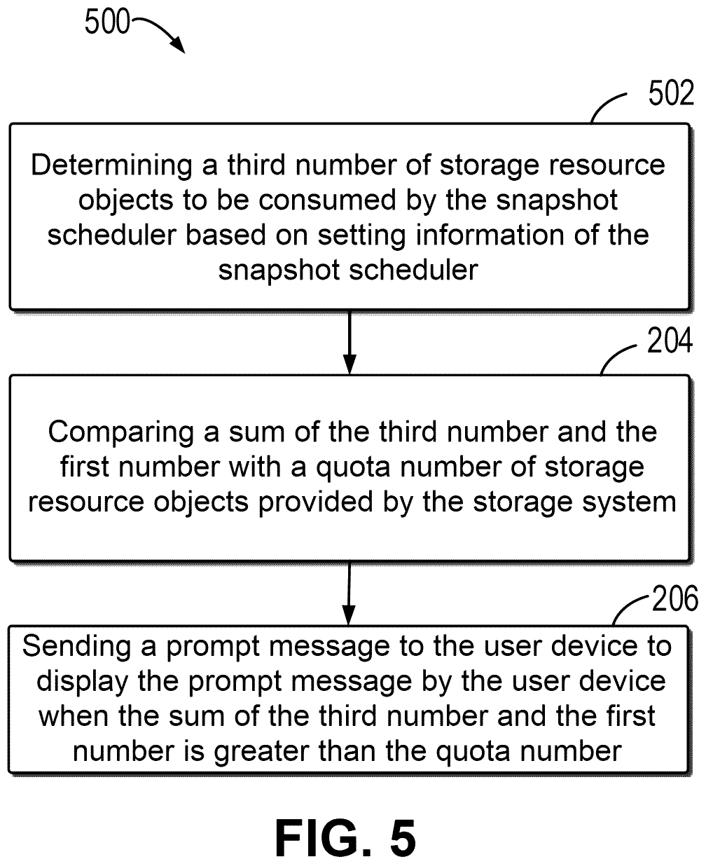

FIG. 5 shows schematic flow chart 500 of monitoring storage resource objects to be consumed by a snapshot scheduler according to an embodiment of the present disclosure. In some embodiments, method 500 may be performed by storage system 120. It should be understood that method 500 may further include additional actions not shown and/or may omit actions shown, and the scope of the present disclosure is not limited in this aspect.

In some embodiments, at block 502, storage system 120 may determine a third number N, of storage resource objects to be consumed by a snapshot scheduler (i.e., the third number N, of snapshots to be created) based on setting information of the snapshot scheduler. In some embodiments, the setting information of the snapshot scheduler may include: a life cycle (K) of a snapshot to be created; a creation interval (D) of a snapshot to be created, i.e., how often to create a snapshot; and the number (N) of system files and/or volumes associated with the snapshot scheduler.

The storage system may calculate the third number N, of storage resource objects to be consumed (i.e., the third number N, of snapshots to be created) based on Formula 1 below:

$${N}_{t} = \frac{K}{D} N \qquad ( Formula 1 )$$

At block 504, storage system 120 may compare a sum Nₛᵤₘ of the third number N, and the first number N_{consumed} with a quota number N_{quota} of available storage resource objects provided by the storage system. In some embodiments, to ensure stability and reliability of storage system 120, the sum Nₛᵤₘ of the third number N, of storage resource objects to be consumed and the first number N_{consumed} of storage resource objects that have been consumed is compared with the quota number N_{quota} of storage resource objects provided by the storage system when determining whether the setting information of the snapshot scheduler is feasible, and the quota number N_{quota} of storage resource objects of the storage system is actually less than the upper-limit number Nₗᵢₘᵢₜ of storage resource objects that storage system 120 can provide so as to provide more margin for storage services provided by storage system 120.

At block 506, when the sum Nₛᵤₘ of the third number N, and the first number N_{consumed} is greater than the quota number N_{quota}, storage system 120 may send a prompt message to user device 110-i to display the prompt message by user device 110-i. In some embodiments, storage system 120 may send the prompt message to one or more of user devices 110-1 to 110-N to display the prompt message, which is not limited in the present disclosure.

For example, still using the example in FIG. 3 as an illustration, assume that the upper-limit number Nₗᵢₘᵢₜ of storage resource objects that storage system 120 can provide is 6500, and the quota number N_{quota} is set to a value less than the upper-limit number Nₗᵢₘᵢₜ, for example 5600. Assume that the number N_{consumed} of storage resource objects that have been consumed currently is 2505. Assume that the setting information of the snapshot scheduler set currently refers to: snapshots are created for 10 system files, a life cycle of each snapshot is 12 hours, and one snapshot is created every one hour, so that the number of snapshots that the storage system needs to retain for these 10 system files after 12 hours is 120, that is, the number of snapshots to be created is 120. The sum Nₛᵤₘ of the third number N, and the first number N_{consumed} is 2625, which is less than the quota number N_{quota}. It can be seen that the setting information of the snapshot scheduler set currently is feasible.

Assuming that the upper-limit number Nₗᵢₘᵢₜ of storage resource objects that storage system 120 can provide is 6500, and the quota number N_{quota} is set to a value less than the upper-limit number Nₗᵢₘᵢₜ, for example, 5000. Assume that the number N_{consumed} of storage resource objects that have been consumed currently is 4800. Further assume that the setting information of the snapshot scheduler set currently refers to: snapshots are created for 40 system files, a life cycle of each snapshot is 12 hours, and one snapshot is created every one hour, so that the number of snapshots that the storage system needs to retain for these 40 system files after 12 hours is 480, that is, the number of snapshots to be created is 480. The sum Nₛᵤₘ of the third number N, and the first number N_{consumed} is 5280, which is greater than the quota number N_{quota}. It can be seen that the setting information of the snapshot scheduler set currently is not feasible. In this case, storage system 120 may prompt the user via user device 110-i.

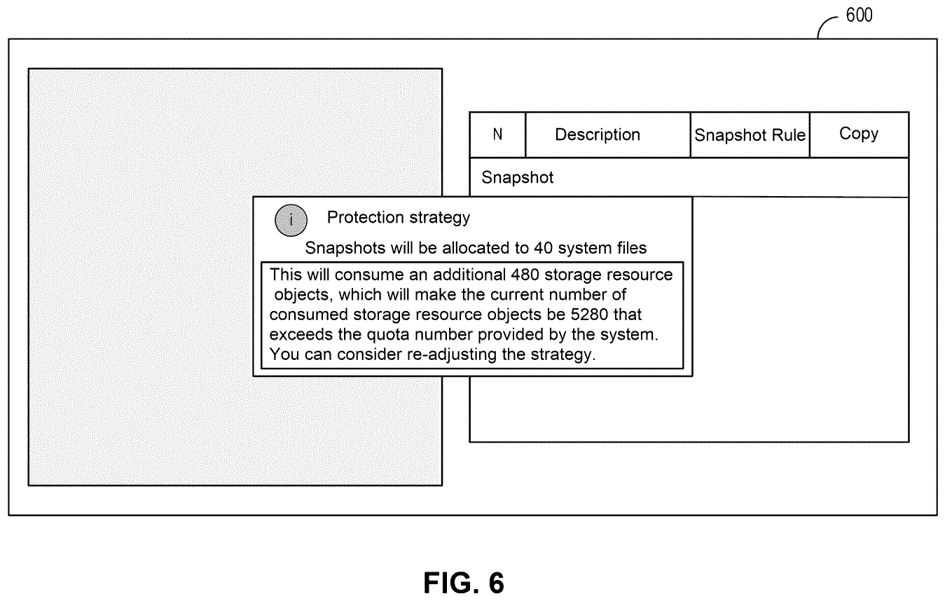

FIG. 6 shows a schematic diagram of an interface for displaying a prompt message at a user device according to an embodiment of the present disclosure. The user device may display the relevant prompt message to the user when receiving an unreasonable protection strategy or setting information currently set for the snapshot scheduler. The content and form of the prompt message in FIG. 6 are only schematic, and the style of the interface in FIG. 6 and the details of the display of the prompt message can be adjusted by those skilled in the art, which is not limited in the present disclosure. In addition, the user device may also prompt the user with the number information of various types of storage resource objects in other ways (e.g., voice and tactile prompts), which is not limited in the present disclosure.

In some embodiments, when the sum Nₛᵤₘ of the third number N, and the first number N_{consumed} is greater than the quota number N_{quota}, the user may modify the setting information of the snapshot scheduler so that storage system 120 modifies the setting information of the snapshot scheduler in response to an input from the user device, thus making the sum Nₛᵤₘ reduced to less than or equal to the quota number N_{quota}. According to Formula 1 above, in order to make the setting information or the protection strategy feasible, the life cycle (K) of a snapshot to be created may be reduced, or the time interval (D) for creating snapshots may be increased, or the life cycle (K) of a snapshot to be created may be reduced and the time interval (D) for creating snapshots may be increased. Accordingly, storage system 120 may, in response to the input from user device 110-i, modify the setting information of the snapshot scheduler in accordance with the input from the user device, so that the sum Nₛᵤₘ is reduced to less than or equal to the quota number N_{quota}.

In some embodiments, in the method according to the embodiments of the present disclosure, one or more interfaces may further be provided in the snapshot scheduler to receive a deletion identifier from this storage system or another storage system (e.g., for a storage cluster that includes multiple storage systems) or other computing devices (e.g., user devices) that is configured for one or more consumed storage resource objects (e.g., snapshots). Accordingly, the snapshot scheduler may delete the at least one consumed storage resource object based on the deletion identifier. After the consumed storage resource object is deleted, the consumed storage resource object is released and can be used by another object. Thus, storage system 120 may update the second number N_{remaining} above using the number of deleted consumed storage resource objects. For example, assuming that 10 consumed storage resource objects are deleted, the storage system may increase the number of remaining storage resource objects by 10 accordingly as storage resource objects that may be further allocated by storage system 120.

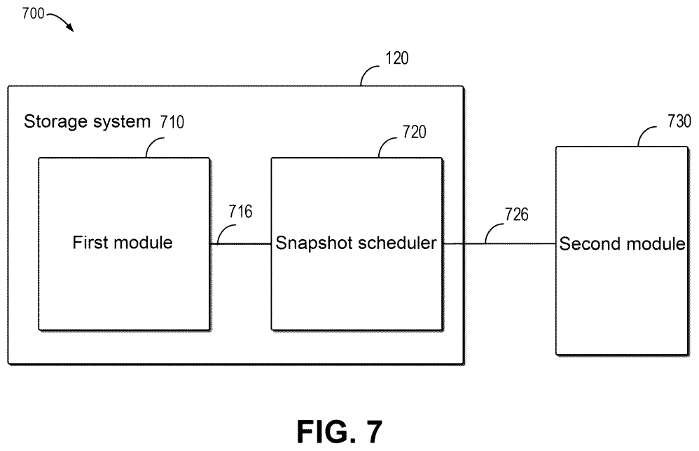

FIG. 7 shows a schematic diagram of a snapshot scheduler providing an interface according to an embodiment of the present disclosure. In FIG. 7, storage system 120 may include snapshot scheduler 720 that may provide one or more interfaces (e.g., interfaces 716, 726) used for other modules to set deletion identifiers for snapshots created by snapshot scheduler 720. Snapshot scheduler 720 may be connected to first module 710 in storage system 120. Snapshot scheduler 720 may also be connected to second module 730 in another storage system or a user device. First module 710 and second module 730 may be various types of software modules or hardware modules or combinations of software and hardware modules, which are configured to set deletion identifiers for snapshots in snapshot scheduler 702.

In some embodiments, when a module (e.g., first module 710 or second module 730) determines that the frequency of use of at least one consumed storage resource object (e.g., a snapshot) is lower than a usage threshold such that no further retention is required, or at least one consumed storage resource object (e.g., a snapshot) is no longer needed for other reasons, or the like, the module may set a deletion identifier for the consumed storage resource object. Snapshot scheduler 720 receives the deletion identifier for the at least one consumed storage resource object via interfaces (e.g., interfaces 716, 726). For example, when first module 710 sets a deletion identifier for the consumed storage resource object, snapshot scheduler 720 may receive the deletion identifier set for the at least one consumed storage resource object via interface 716. When second module 730 sets a deletion identifier for the consumed storage resource object, snapshot scheduler 720 may receive the deletion identifier set for the at least one consumed storage resource object via interface 726. Snapshot scheduler 720 may delete the at least one consumed storage resource object based on the deletion identifier.

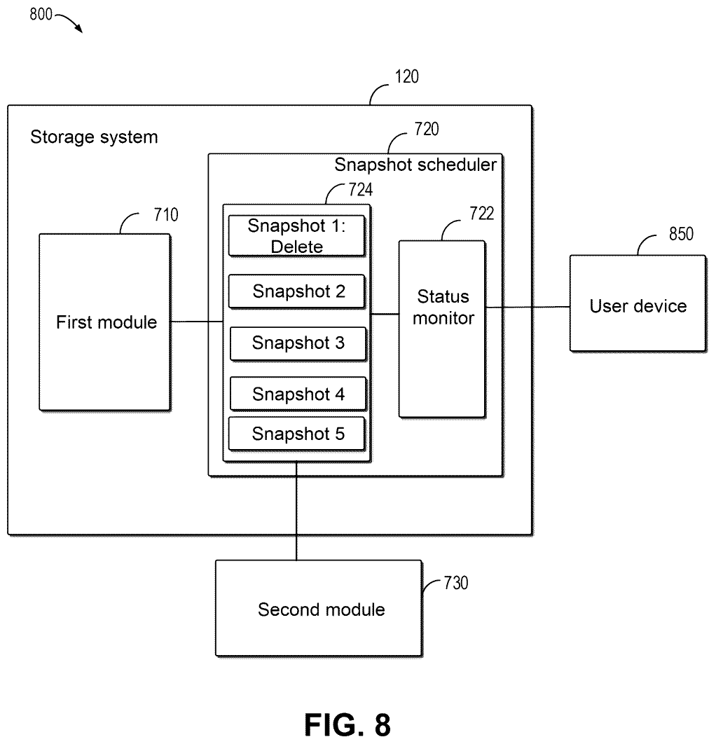

FIG. 8 shows a detailed schematic block diagram of a snapshot scheduler providing an interface according to an embodiment of the present disclosure. FIG. 8 is similar to FIG. 7, where snapshot module 724 and status monitor 722 of snapshot scheduler 720 are illustrated in detail in FIG. 8. First module 710 and/or second module 730 may set a deletion identifier for a snapshot based on conditions such as the frequency of access to the snapshot and whether the snapshot will continue to be used. For example, assume that first module 710 sets snapshot 1 to a state where it can be deleted, as shown in FIG. 8. Status monitor 722 in snapshot scheduler 720 may monitor the status of each snapshot in snapshot module 724. When it is determined that a snapshot in snapshot module 724 has a deletion identifier, status monitor 722 may delete the snapshot with the deletion identifier, thereby releasing the corresponding storage resource object. For example, as shown in FIG. 8, when status monitor 722 determines that snapshot 1 has a deletion identifier, status monitor 722 may delete snapshot 1 and add 1 to the second number N_{remaining}.

Also shown in FIG. 8 is user device 850, and user device 850 may be at least one of user devices 110-1 to 110-N in FIG. 1. After deleting the snapshot with the deletion identifier, status monitor 722 may send the information of deleting the snapshot to user device 850. User device 850 may display the updated second number N_{remaining} in user interface 300 and may also prompt the user that a snapshot has currently been deleted by means of visual display, voice broadcast, and the like, and prompt the user with the updated second number N_{remaining}.

It can be understood that the schematic diagram in FIG. 8 is only illustrative. Snapshot module 724 in FIG. 8 may have various numbers of snapshots, and the snapshots may be snapshots of a system file, snapshots of a volume, snapshots of other objects, and the like. In addition, although two modules are illustrated in FIG. 8 to set deletion identifiers for snapshots, there may be other various numbers and types of modules to set deletion identifiers for snapshots. Moreover, trigger conditions for setting deletion identifiers for snapshots are not limited to the frequency of usage of the snapshots, whether the snapshots will continue to be used, and the like. Other trigger conditions may exist based on actual needs and requirements, which is not limited in the present disclosure.

In some embodiments, storage system 120 may be a storage node in a storage cluster in which multiple storage systems are integrated. The storage cluster may further include other storage systems as storage nodes of the storage cluster, thereby providing the user with more flexible storage services with a greater storage capacity. In such storage cluster, when it is determined that the first number N_{consumed} of consumed storage resource objects in this storage system reaches the quota number N_{quota} of storage resource objects provided by this storage system, storage system 120 may also migrate at least one consumed storage resource object in this storage system to another storage system. A part of the storage resources in this system can thus be released, thereby reserving storage resources for performing storage processing on objects of a higher priority to further improve the stability and reliability of the storage system.

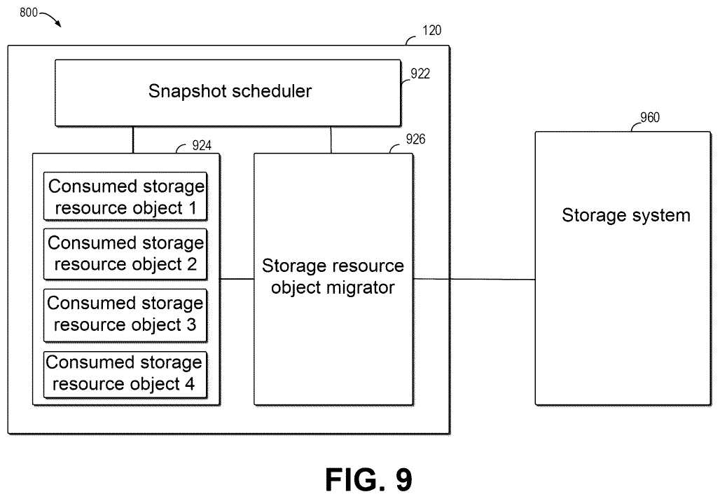

FIG. 9 shows a schematic block diagram of migration of storage resource objects according to an embodiment of the present disclosure. As shown in FIG. 9, storage system 120 and another storage system 960 are a part of a storage cluster. Although not shown, it is to be understood that other various types of components may be included in the storage cluster. Storage system 120 includes snapshot scheduler 922, resource object container 924 configured to store storage resource objects that have been consumed, and storage resource object migrator 926.

In some embodiments, snapshot scheduler 922 is configured to monitor the consumption of resource objects in storage system 120. When snapshot scheduler 922 determines that the first number N_{consumed} of consumed storage resource objects in storage system 120 reaches the quota number N_{quota} of storage resource objects provided by the storage system, snapshot scheduler 922 may send a trigger signal to storage resource object migrator 926 to migrate a part of the consumed storage resource objects in resource object container 924 to another storage system 960.

In some embodiments, when resource object container 924 receives the trigger signal, a part of the consumed storage resource objects can be selected from resource object container 924 and then migrated to another storage system 960. In some embodiments, snapshot scheduler 922 may monitor the usage of each consumed storage resource object and select the least frequently used storage resource as a migrated object. In some embodiments, snapshot scheduler 922 may send an identifier of the least frequently used storage resource object to storage resource object migrator 926 along with the trigger signal, so that storage resource object migrator 926 migrates the least frequently used storage resource object to another storage system 960. For example, as shown in FIG. 9, snapshot scheduler 922 may monitor that storage resource object 1 that has been consumed is used least frequently, and then may instruct storage resource object migrator 926 to migrate storage resource object 1 that has been consumed to storage system 960 to release the storage resource space in storage system 120. In addition, the snapshot scheduler may also sequentially select the consumed storage resource objects that are used the next least frequently and instruct storage resource object migrator 926 to migrate them to storage system 960, and so on.

It is advantageous that, in the storage cluster, by monitoring the consumption of storage resource objects in the storage system nodes and migrating a part of storage resource objects in the storage system in which the quota number of storage resource objects provided by the storage system is reached to another storage system, the advantages of clustering can be fully used, making the utilization of storage resources relatively uniform and providing more stable and reliable storage services for the user.

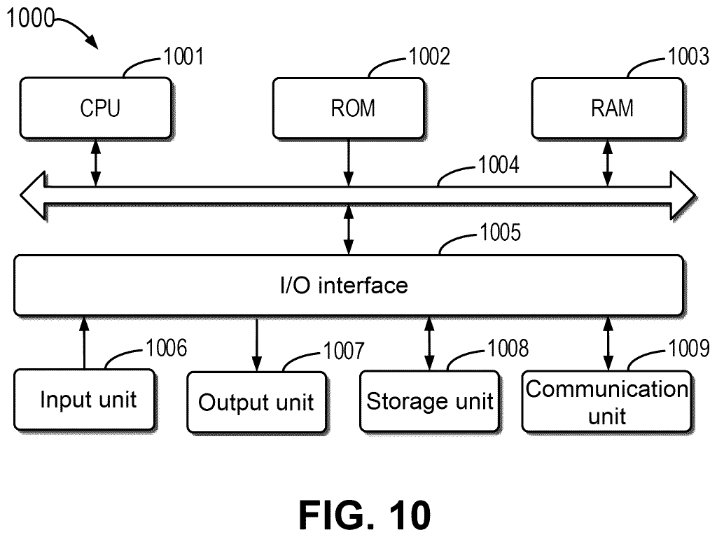

FIG. 10 illustrates a schematic block diagram of example device 1000 that can be used to implement embodiments of the present disclosure. Storage system 120 in FIG. 1 may be implemented by device 1000. As shown in the figure, device 1000 includes central processing unit (CPU) 1001 that may perform various appropriate actions and processing according to computer program instructions stored in read-only memory (ROM) 1002 or computer program instructions loaded from storage unit 708 into random access memory (RAM) 1003. Various programs and data required for the operation of device 1000 may also be stored in RAM 1003. CPU 1001, ROM 1002, and RAM 1003 are connected to one other through bus 1004. Input/output (I/O) interface 1005 is also connected to bus 1004.

A plurality of components in device 1000 are connected to I/O interface 1005, including: input unit 1006, such as a keyboard and a mouse; output unit 1007, such as various types of displays and speakers; memory page 1008, such as a disk or an optical disk; and communication unit 1009, such as a network card, a modem, and a wireless communication transceiver. Communication unit 1009 allows device 1000 to exchange information/data with other devices via a computer network, such as the Internet, and/or various telecommunication networks.

The various processes and processing described above, such as method 200, may be performed by processing unit 1001. For example, in some embodiments, method 200 may be implemented as a computer software program that is tangibly included in a machine-readable medium such as storage unit 1008. In some embodiments, part or all of the computer program may be loaded and/or installed to device 1000 via ROM 1002 and/or communication unit 1009. When the computer program is loaded into RAM 1003 and executed by CPU 1001, one or more actions of method 200 described above may be implemented.

The present disclosure may be a method, an apparatus, a system, and/or a computer program product. The computer program product may include a computer-readable storage medium on which computer-readable program instructions for performing various aspects of the present disclosure are loaded.

The computer-readable storage medium may be a tangible device that may retain and store instructions used by an instruction-executing device. For example, the computer-readable storage medium may be, but is not limited to, an electric storage device, a magnetic storage device, an optical storage device, an electromagnetic storage device, a semiconductor storage device, or any suitable combination of the foregoing. More specific examples (a non-exhaustive list) of the computer-readable storage medium include: a portable computer disk, a hard disk, a random access memory (RAM), a read-only memory (ROM), an erasable programmable read-only memory (EPROM or flash memory), a static random access memory (SRAM), a portable compact disc read-only memory (CD-ROM), a digital versatile disc (DVD), a memory stick, a floppy disk, a mechanical encoding device, for example, a punch card or a raised structure in a groove with instructions stored thereon, and any suitable combination of the foregoing. The computer-readable storage medium used herein is not to be interpreted as transient signals per se, such as radio waves or other freely propagating electromagnetic waves, electromagnetic waves propagating through waveguides or other transmission media (e.g., light pulses through fiber-optic cables), or electrical signals transmitted through electrical wires.

The computer-readable program instructions described herein may be downloaded from a computer-readable storage medium to various computing/processing devices or downloaded to an external computer or external storage device over a network, such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from a network and forwards the computer-readable program instructions for storage in a computer-readable storage medium in each computing/processing device.

The computer program instructions for executing the operation of the present disclosure may be assembly instructions, instruction set architecture (ISA) instructions, machine instructions, machine-dependent instructions, microcode, firmware instructions, status setting data, or source code or object code written in any combination of one or a plurality of programming languages, the programming languages including object-oriented programming languages such as Smalltalk and C++, and conventional procedural programming languages such as the C language or similar programming languages. The computer-readable program instructions may be executed entirely on a user computer, partly on a user computer, as a stand-alone software package, partly on a user computer and partly on a remote computer, or entirely on a remote computer or a server. In a case where a remote computer is involved, the remote computer may be connected to a user computer through any kind of networks, including a local area network (LAN) or a wide area network (WAN), or may be connected to an external computer (for example, connected through the Internet using an Internet service provider). In some embodiments, an electronic circuit, such as a programmable logic circuit, a field programmable gate array (FPGA), or a programmable logic array (PLA), is customized by utilizing status information of the computer-readable program instructions. The electronic circuit may execute the computer-readable program instructions so as to implement various aspects of the present disclosure.

Various aspects of the present disclosure are described here with reference to flow charts and/or block diagrams of the method, the apparatus (system), and the computer program product according to the embodiments of the present disclosure. It should be understood that each block of the flow charts and/or the block diagrams and combinations of blocks in the flow charts and/or the block diagrams may be implemented by computer-readable program instructions.

These computer-readable program instructions may be provided to a processing unit of a general-purpose computer, a special-purpose computer, or a further programmable data processing apparatus, thereby producing a machine, such that these instructions, when executed by the processing unit of the computer or the further programmable data processing apparatus, produce means (e.g., specialized circuitry) for implementing functions/actions specified in one or a plurality of blocks in the flow charts and/or block diagrams. These computer-readable program instructions may also be stored in a computer-readable storage medium, and these instructions cause a computer, a programmable data processing apparatus, and/or other devices to operate in a specific manner; and thus the computer-readable medium having instructions stored includes an article of manufacture that includes instructions that implement various aspects of the functions/actions specified in one or a plurality of blocks in the flow charts and/or block diagrams.

The computer-readable program instructions may also be loaded to a computer, a further programmable data processing apparatus, or a further device, so that a series of operating steps may be performed on the computer, the further programmable data processing apparatus, or the further device to produce a computer-implemented process, such that the instructions executed on the computer, the further programmable data processing apparatus, or the further device may implement the functions/actions specified in one or a plurality of blocks in the flow charts and/or block diagrams.

The flow charts and block diagrams in the drawings illustrate the architectures, functions, and operations of possible implementations of the systems, methods, and computer program products according to various embodiments of the present disclosure. In this regard, each block in the flow charts or block diagrams may represent a module, a program segment, or part of an instruction, the module, program segment, or part of an instruction including one or a plurality of executable instructions for implementing specified logical functions. In some alternative implementations, functions marked in the blocks may also occur in an order different from that marked in the accompanying drawings. For example, two successive blocks may actually be executed in parallel substantially, and sometimes they may also be executed in a reverse order, which depends on involved functions. It should be further noted that each block in the block diagrams and/or flow charts as well as a combination of blocks in the block diagrams and/or flow charts may be implemented using a dedicated hardware-based system that executes specified functions or actions, or using a combination of special hardware and computer instructions.

The embodiments of the present disclosure have been described above. The above description is illustrative, rather than exhaustive, and is not limited to the disclosed various embodiments. Numerous modifications and alterations are apparent to persons of ordinary skill in the art without departing from the scope and spirit of the illustrated embodiments. The selection of terms used herein is intended to best explain the principles and practical applications of the various embodiments or the technological improvements to technologies on the market, or to enable other persons of ordinary skill in the art to understand the embodiments disclosed herein.

1. A method for monitoring storage resource objects, the method comprising:
monitoring a first number of storage resource objects that have been consumed in a storage system, the consumed storage resource objects storing a system file and/or volume and snapshots of the system file and/or snapshots of the volume;
determining a second number of remaining storage resource objects based on the first number and the performance of the storage system; and
sending the first number and the second number to a user device to display the first number and the second number by the user device,
wherein the second number decreases as the first number increases.

2. The method according to claim 1, wherein the first number comprises the number of snapshots of the system file and/or snapshots of the volume created by a snapshot scheduler for the system file and/or the volume.

3. The method according to claim 1, wherein the consumed storage resource objects are used for at least one of: a system file, snapshots of the system file, a volume, or snapshots of the volume.

4. The method according to claim 1, wherein the method further comprises:
determining a third number of storage resource objects to be consumed by the snapshot scheduler based on setting information of the snapshot scheduler;
comparing a sum of the third number and the first number with a quota number of storage resource objects provided by the storage system; and
sending a prompt message to the user device to display the prompt message by the user device when the third number is greater than the quota number.

5. The method according to claim 4, further comprising:
when the sum of the third number and the first number is greater than the quota number, modifying the setting information of the snapshot scheduler in response to an input from the user device, so that the sum is reduced to less than or equal to the quota number.

6. The method according to claim 4, wherein the quota number is less than an upper-limit number of storage resource objects provided by the storage system.

7. The method according to claim 4, wherein the setting information of the snapshot scheduler comprises at least one of the following items:
a life cycle of a snapshot to be created;
a time interval of the snapshot to be created; or
the number of system files and/or volumes associated with the snapshot scheduler.

8. The method according to claim 1, further comprising:
receiving, by a snapshot scheduler via an interface, a deletion identifier set for at least one consumed storage resource object;
deleting the at least one consumed storage resource object by the snapshot scheduler based on the deletion identifier; and
updating the second number with the number of the at least one consumed storage resource object that was deleted.

9. The method according to claim 8, wherein the snapshot scheduler receives the deletion identifier set for the at least one consumed storage resource object via the interface when the frequency of use of the at least one consumed storage resource object is lower than a usage threshold.

10. The method according to claim 1, further comprising:
determining that the first number of storage resource objects that have been consumed in the storage system reaches the quota number of storage resource objects provided by the storage system; and
migrating at least one consumed storage resource object in the storage system to another storage system.

11. An electronic device, comprising:
at least one processor; and
a memory coupled to the at least one processor and having instructions stored thereon, wherein the instructions, when executed by the at least one processor, cause the electronic device to perform actions comprising:
monitoring a first number of storage resource objects that have been consumed in a storage system, the consumed storage resource objects storing a system file and/or volume and snapshots of the system file and/or snapshots of the volume;
determining a second number of remaining storage resource objects based on the first number and the performance of the storage system; and
sending the first number and the second number to a user device to display the first number and the second number by the user device,
wherein the second number decreases as the first number increases.

12. The electronic device according to claim 11, wherein the first number comprises the number of snapshots of the system file and/or snapshots of the volume created by a snapshot scheduler for the system file and/or the volume.

13. The electronic device according to claim 11, wherein the consumed storage resource objects are used for at least one of: a system file, snapshots of the system file, a volume, or snapshots of the volume.

14. The electronic device according to claim 11, wherein the instructions, when executed by the at least one processor, further cause the electronic device to perform actions comprising:
determining a third number of storage resource objects to be consumed by the snapshot scheduler based on setting information of the snapshot scheduler;
comparing a sum of the third number and the first number with a quota number of storage resource objects provided by the storage system; and
sending a prompt message to the user device to display the prompt message by the user device when the third number is greater than the quota number.

15. The electronic device according to claim 14, wherein the instructions, when executed by the at least one processor, further cause the electronic device to perform actions comprising:
when the sum of the third number and the first number is greater than the quota number, modifying the setting information of the snapshot scheduler in response to an input from the user device, so that the sum is reduced to less than or equal to the quota number.

16. The electronic device according to claim 14, wherein the quota number is less than an upper-limit number of storage resource objects provided by the storage system.

17. The electronic device according to claim 14, wherein the setting information of the snapshot scheduler comprises at least one of the following items:
a life cycle of a snapshot to be created;
a time interval of the snapshot to be created; or
the number of system files and/or volumes associated with the snapshot scheduler.

18. The electronic device according to claim 11, wherein the instructions, when executed by the at least one processor, further cause the electronic device to perform actions comprising:
receiving, by a snapshot scheduler via an interface, a deletion identifier set for at least one consumed storage resource object;
deleting the at least one consumed storage resource object by the snapshot scheduler based on the deletion identifier; and
updating the second number with the number of the at least one consumed storage resource object that was deleted.

19. The electronic device according to claim 18, wherein the instructions, when executed by the at least one processor, further cause the electronic device to perform actions comprising:
determining that the first number of storage resource objects that have been consumed in the storage system reaches the quota number of storage resource objects provided by the storage system; and
migrating at least one consumed storage resource object in the storage system to another storage system.

20. A computer program product having a non-transitory computer readable medium which stores a set of instructions to monitor storage resource objects; the set of instructions, when carried out by computerized circuitry, causing the computerized circuitry to perform a method of:
monitoring a first number of storage resource objects that have been consumed in a storage system, the consumed storage resource objects storing a system file and/or volume and snapshots of the system file and/or snapshots of the volume;
determining a second number of remaining storage resource objects based on the first number and the performance of the storage system; and
sending the first number and the second number to a user device to display the first number and the second number by the user device,
wherein the second number decreases as the first number increases.
